(19) United States
(12) Patent Application Publication
(10) Pub. No.: US 2025/0371354 A1
(43) Pub. Date: Dec. 4, 2025

(54) EVALUATING LOCAL INTRINSIC DIMENSIONALITY FOR DIFFUSION MODELS

(71) Applicant: THE TORONTO-DOMINION BANK, TORONTO (CA)

(72) Inventors: Hamidreza Kamkari, TORONTO (CA); Brendan Leigh Ross, TORONTO (CA); Jesse Cole Cresswell, TORONTO (CA); Rasa Hosseinzadeh, TORONTO (CA); Gabriel Loaiza Ganem, TORONTO (CA); Maksims Volkovs, TORONTO (CA)

(21) Appl. No.: 19/223,581

(22) Filed: May 30, 2025

Related U.S. Application Data
(60) Provisional application No. 63/654,392, filed on May 31, 2024.

(51) Int. Cl. G06N 3/088

(52) U.S. Cl. CPC G06N 3/088

(57) ABSTRACT

The local intrinsic dimensionality (LID) for a diffusion model with respect to a particular data sample is determined by using the diffusion model's diffusion process to apply noise to a data sample and evaluate how the estimated log probability of the data sample changes at different levels of noise. Particularly, the differential of change in noise to change in log probability can be used to determine the local intrinsic dimensionality. This may be determined by evaluating the log probability at several noise levels and determining a slope of the difference. In additional examples, the differential is evaluated directly at a selected noise level. The selected noise level can be optimized by calculating the estimated LID for various data samples at a variety of noise levels and selecting the LID that corresponds to a “knee” where the estimated LID sharply changes.

### CROSS-REFERENCE TO RELATED APPLICATION

This application claims the benefit of U.S. Provisional Application No. 63/654,392, filed May 31, 2024, the contents of which is hereby incorporated by reference in its entirety.

### BACKGROUND

This disclosure relates generally to evaluating diffusion models, and more particularly to evaluating local intrinsic dimensionality for a data sample according to parameters of a pre-trained diffusion model.

The manifold hypothesis, which has been empirically verified in contexts ranging from natural images to calorimeter showers in physics, states that high-dimensional data of interest with a dimensionality D often lies on low-dimensional submanifolds of D. For a given data sample x, this hypothesis motivates using its local intrinsic dimension (LID), denoted LID(x), as a natural measure of its complexity. LID(x) corresponds to the dimension of the data manifold that x belongs to, and can be intuitively understood as the minimal number of variables needed to describe x. Data manifolds are typically not known explicitly, meaning that LID must be estimated.

This is a longstanding problem, with LID estimates being highly useful due to their innate interpretation as a measure of complexity. For example, these estimates can be used to detect outliers, AI-generated text, and adversarial examples. Connections between the generalization achieved by a neural network and the LID estimates of its internal representations have also been shown. These insights can be leveraged to identify which representations contain maximal semantic content and help explain why LID estimates can be helpful as regularizers and for pruning large models. LID estimation is thus not only of mathematical and statistical interest, but can also benefit the empirical performance of deep learning models at numerous tasks.

Traditional estimators of intrinsic dimension typically measure LID for data samples according to the data set (i.e., “model-free”) with approaches that rely on pairwise distances and nearest neighbors, so computing them is prohibitively expensive for large data sets. In addition, these approaches typically measure data samples with respect to the overall data set, and do not directly measure how a particular model has learned the local space around a data sample. Rather than measuring the LID for the data set generally (i.e., the underlying complexity of the data set), it may also be beneficial to evaluate determine the LID of a data sample as represented by a specific model's trained parameters. To successfully generate new data samples, generative models implicitly learn dimensions of data manifolds. However, existing model-based estimators suffer from various drawbacks, including being inaccurate and computationally expensive, do not apply to diffusion models, require training several models (rather than evaluating one particular model), or alter a training procedure rather than relying on a pre-trained model. Importantly, none of these methods are effective for determining data sample LID for diffusion models trained for generation and efficiently scale to high-resolution images, such as those generated by Stable Diffusion.

### SUMMARY

To effectively measure the local intrinsic dimensionality of a data point with respect to the trained parameters of a diffusion model, the relationship is determined between noise applied by the noising process (in diffusing data samples) and the evaluated change in probability according to the trained parameters for denoising data samples. This relationship may be determined in various ways in different embodiments. In one embodiment, the data sample is diffused at a plurality of noise levels corresponding to different steps of the diffusion process of the diffusion model. At each step/noise level, the log probability is evaluated and the differential may be determined based on a slope of the log probability as the noise level changes. The trajectory of data sample distributions at different noise levels and the corresponding log probabilities may be evaluated in one approach with one call to a differential equation solver.

In an additional embodiment, the rate of change of marginal log probabilities of the diffusion process may be calculated directly at a selected noise level. Although the behavior of diffusion models may be unstable at low noise levels, low noise levels also represent the lowest “scale” for evaluating the expected LID. To determine the appropriate noise level for evaluating the LID of the model, the LID may be calculated at a plurality of time steps for one or more data samples of the data set and used to identify the noise level at which there is a “knee” in the estimated LID, which may be determined by a region of maximum change in predicted LID. The selected noise level may then be used to evaluate LID based on a differential of the log probability with respect to differential noise without requiring a differential equation solver. In addition, this approach is differentiable, such that LID estimates for the data sample may also be backpropagated.

Using these approaches, the LID for a data sample according to the trained parameters of the diffusion model can be evaluated, which provides an effective measure of the complexity of the data sample (according to the model parameters). The LID for the data sample may be applied to evaluate generated data samples, detect memorization of data samples, evaluate whether an arbitrary data sample is expected to be in-distribution with respect to the model, and so forth, in ways that were previously not effective for diffusion models at scale.

### BRIEF DESCRIPTION OF THE DRAWINGS

FIG. 1 illustrates an example generative modeling system, according to one embodiment.

FIG. 2 show examples of a diffusion model that may be evaluated for a local intrinsic dimensionality of a data sample, according to one or more embodiments.

FIG. 3 provides an example data flow for estimating the local intrinsic dimensionality of a data sample, according to one embodiment.

FIG. 4 shows an example for estimating a local intrinsic dimensionality at a noise level, according to one embodiment.

FIG. 5 shows examples of the estimated LID for data samples as the evaluated noise level changes, according to one embodiment.

FIG. 6 shows a further example of how the selection of a noise level can affect LID estimates.

FIG. 7 shows an additional example of determining a noise level for evaluating local intrinsic dimensionality.

FIG. 8 provides an additional illustration of the estimated local intrinsic dimensionality of data points in a variety of data sets, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

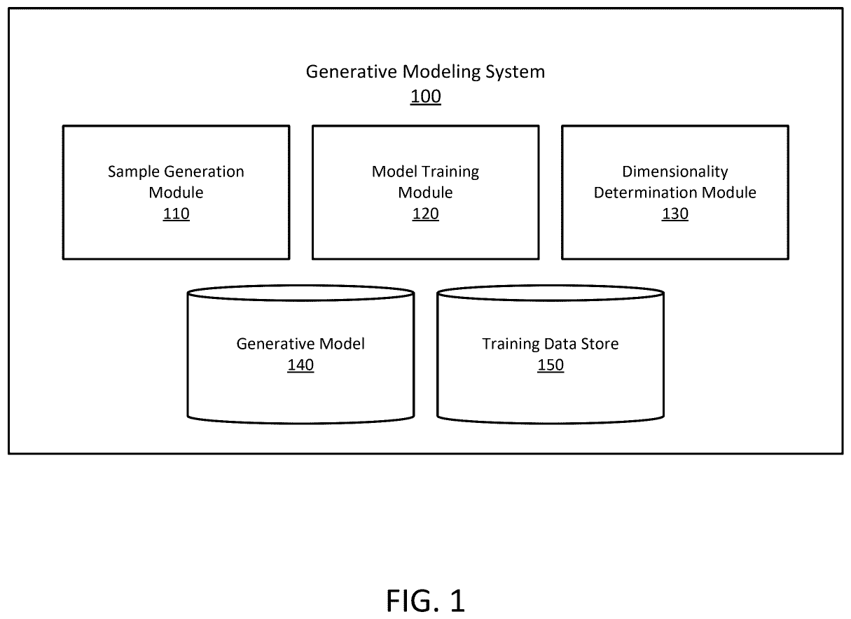

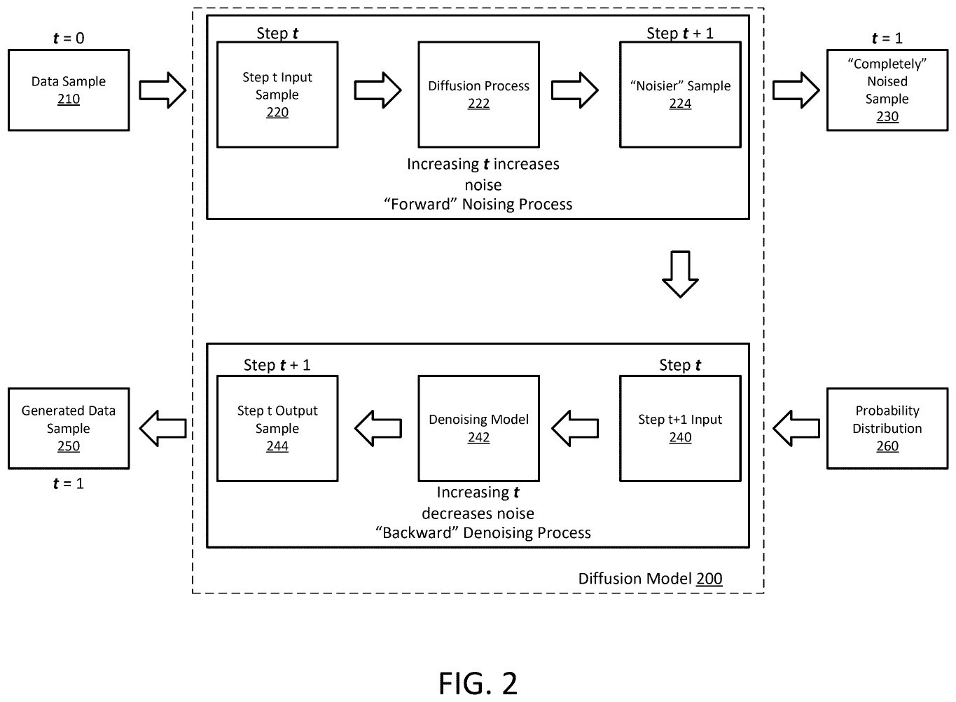

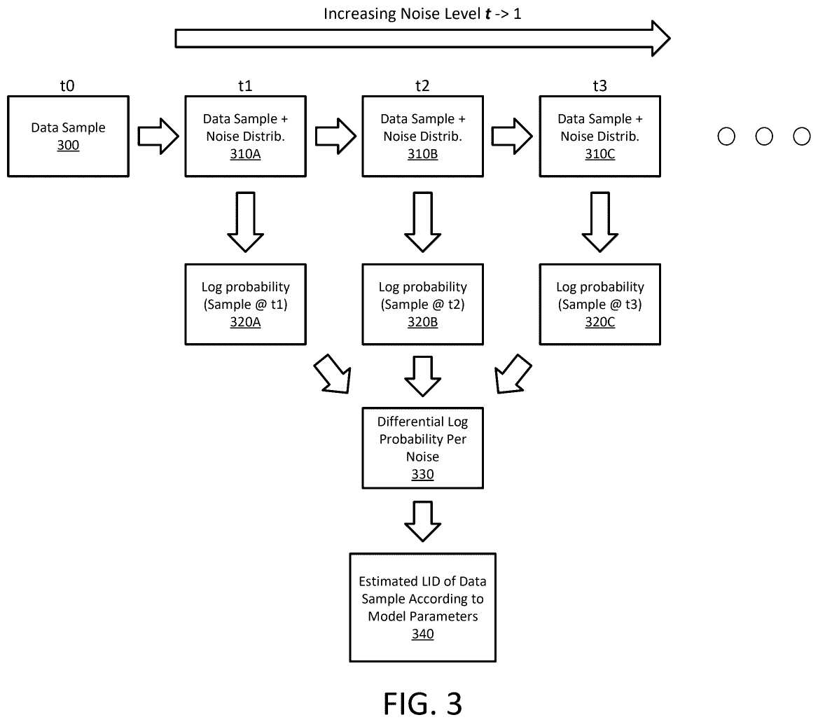

FIG. 1 illustrates an example generative modeling system 100, according to one embodiment. The generative modeling system 100 trains and applies a generative model 140 that may create new data samples based on learned parameters of the generative model 140. The generative model 140 is a diffusion model that may include a noising and denoising process, as discussed further with respect to FIGS. 2-3. Although, for convenience, the model training and model application (i.e., new data sample generation) are discussed herein as performed by the generative modeling system 100; in practice, one system (or set of systems) may train the generative model 140, and another set of systems may apply the generative model 140 to generate new data samples. As discussed further below, the generative modeling system 100 may use a “geometric” understanding of the generative model 140 to determine a local intrinsic dimensionality (LID) of a data sample according to the model's parameters. The LID as evaluated for a data sample (x) according to the model parameters θ may be denoted LID_{θ}(x). In particular, the generative modeling system 100 includes a dimensionality determination module 130 that may determine LID_{θ}(x) for a data sample based on trained parameters θ of the generative model 140.

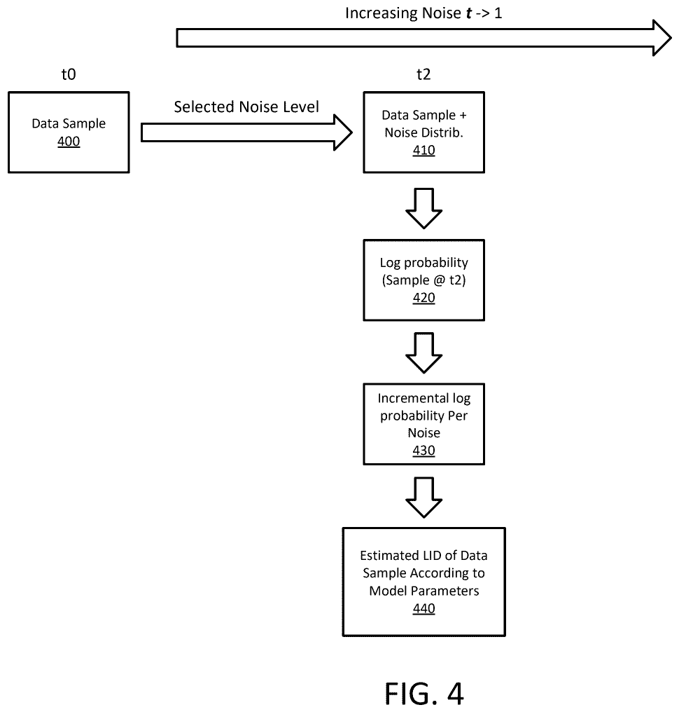

As such, a dimensionality determination module 130 determines an LID with reference to trained parameters of the generative model 140. In that sense, the determined LID_{θ}(x) describes the LID of the datapoint x with respect to the model's “understanding” of the data domain as represented by the model's learned parameters θ. The LID may also be understood as describing degrees of freedom or complexity of the data sample and the generative model's capacity to generate alternate “similar” data samples. The generative model 140 may include notions of probability, such that probability mass and/or density can be evaluated for a data sample. As discussed further below, the dimensionality determination module 130 uses a “dimensional” understanding of the generative model 140 by evaluating how noise levels affect the evaluated probability of the data sample. Particularly, the dimensionality determination module 130 determines LID_{θ}(x) based on a differential change in the probability with respect to the change in the noise level. The evaluation of the local intrinsic dimensionality for a data sample is discussed in further detail below with respect to FIG. 4 et seq.

In general, the generative model 140 has its parameters trained on a set of training data samples before evaluation by the dimensionality determination module 130. In general, a set of training data samples, which may be stored in a training data store 150, may be used to train the generative model 140. The particular type of training data differs across different embodiments and may include images, video, text, tabular data, and other types of data. The training data generally may include hundreds, thousands, millions, or more of individual data samples for use by a computer model. Each data sample may include a number of features/values that vary across a number of dimensions and may be organized as an array, matrix, or other high-dimensional structure. For example, a multi-color image is generally composed of a matrix comprising dimensions corresponding to the height and width of the image and a number of color channels, such that an individual pixel (i.e., a position) in the image is described by a particular height, width, and color values for each color channel. Each data sample may also include a number of labels or other additional information used for training the generative model 140. Images are generally used in this disclosure as an example of a type of data sample that may be used; additional types of data samples with additional characteristics may be used in other embodiments.

This natural data is often observed, captured, or otherwise represented in a “high-dimensional” space of n dimensions ( [symbol] ⁿ). While the data may be represented in this high-dimensional space, data of interest typically exists on a manifold [symbol] having lower dimensionality [symbol] ^{m} than the high-dimensional space (n>m). The manifold dimensionality may also be referred to herein as a dimensionality of a latent space that may be mapped to the manifold or as the “intrinsic” dimensionality of the data set, which may differ in different regions of the data set. As such, the overall manifold learned by the model may be a “union of manifolds” representing the different manifolds in different regions of the data. In general, the data samples in the training data store 150 exist in such a “high-dimensional” space. As one example, for image data, the “high-dimensional” space in which images could exist includes all possible color values across all color channels at each pixel position across the height and width of an image. Meanwhile, the training data for particular applications typically occupies a small subset of those possible images.

During the training process, the generative model 140 implicitly attempts to learn the relevant regions of the high-dimensional space (together forming a manifold [symbol] ) and, typically, a probability distribution across it. The generative model 140 may be referred to as a “deep” generative model, as it may include a large number of model parameters and multiple layers of model parameters that may be modified during the training process to learn the relevant regions and probability distribution. The particular number of tunable parameters for the generative model 140 varies in different embodiments and may include hundreds, thousands, tens of thousands, millions, or more tunable parameters. Generative models 140 may particularly include diffusion models (DMs), which are capable of learning a low-dimensional structure that may differ across regions of the output space. However, the approach discussed herein may apply to additional types of generative models. In general, the generative model 140 attempts to learn the unknown probability distribution of the ground truth distribution by maximizing the likelihood of the training data. As such, the generative model 140 can include a probability distribution that can be sampled from and transformed to a point (i.e., a data sample) in the high-dimensional space.

In various embodiments, the generative model 140 may also be trained to generate data samples in conjunction with (e.g., conditioned on) a query. The training data store 150 may include one or more queries associated with each training data sample, such that the generative model 140 learns to generate data samples based on an input query. The query may typically be a sequence of textual tokens, such as a sentence associated with and describing the data sample.

A model training module 120 trains the generative model 140 based on the set of training data samples from the training data store 150. The model training module 120 may use any suitable machine-learning techniques to train parameters of the generative model 140 based on the type and architecture of the generative model 140. Such techniques may include supervised or unsupervised training techniques, evaluation of error/loss functions, backpropagation, gradient descent, and so forth, which may vary in different embodiments and for different applications.

Samples from the generative model 140 may be generated by the sample generation module 110, for example based on requests from additional systems. These additional systems may provide textural queries or other parameters for generating a data sample by the sample generation module 110. The particular method for generating data samples may vary in different embodiments and may include sampling from a probability distribution associated with the generative model 140 and applying parameters of the generative model 140 to obtain a generated data sample in the data space.

A sample generation module 110, the model training module 120, and other types of modules may use the dimensionality determination module 130 to evaluate the LID_{θ}(x) of a data sample with respect to the generative model 140 for various purposes. These may be used, for example, for evaluating learned data sample complexity, model memorization of a data sample, out-of-distribution detection, generalization achieved by the network, detecting AI-generated text or adversarial examples, and so forth.

For example, the sample generation module 110 may generate a data sample with the generative model 140 and use the dimensionality determination module 130 to estimate the LID of the generated data sample. The LID may then be used to verify that the generated data sample is generated from a region of the model with sufficient complexity. Similarly, the model training module 120 may use the LID_{θ}(x) to verify that the model has successfully learned a known or estimated LID of the data set as a whole. As a further example, the generative model 140 and evaluated LID_{θ}(x) may be used for whether a data sample is in-distribution or out-of-distribution, which may be used to evaluate whether a data sample should be used for another model trained on a certain data distribution. For example, a classifier and the generative model 140 may be trained on a set of image data, and a new image may be evaluated with LID_{θ}(x) to determine whether the new image is in-distribution for the training data set (in which case, the classifier may be more-reliably applied) or out-of-distribution (in which case, the new image significantly differs from the data used to train the classifier and may not be reliable). In general, because the LID_{θ}(x) indicates the model's learned data space complexity in the region of the data sample, in various contexts, it may be used to evaluate data samples, generated data samples, and the quality of the trained model (e.g., to modify training process and/or architectures).

Although these components are shown in FIG. 1 as part of a generative modeling system 100, in additional embodiments, these components may be located at various separate systems. For example, in one embodiment, the generative model 140 is trained by one computing system, while another computing system generates new data samples based on the trained generative model 140. Similarly, individual components of the generative modeling system 100 may also be distributed across multiple computing systems. For example, the model training module 120 may be distributed across multiple training systems, such that one set of systems is configured to jointly train the generative model 140, and another set of distributed systems is configured to apply the generative model 140 to create new data samples. Each of these systems may include a dimensionality determination module 130 to evaluate the learned dimensionality of the data space around a data sample.

FIG. 2 show examples of a diffusion model that may be evaluated for a local intrinsic dimensionality of a data sample, according to one or more embodiments. A diffusion model 200 typically include two portions, a “forward” process that adds noise to a data sample according to a noise level and a “backward” process that removes noise from a data sample having a specified noise level. The noise level at a particular point in the process is typically specified based on a value t selected from a range between zero and one.

As shown in the approximation of FIG. 2, a forward noising process is applied to a data sample 210 that, when applied to the full noise level at t=1, results in a completely noised sample 230. The forward noising process at each “step” of t receives a step t input sample 220 (denoted Xₜ) and applies a diffusion process 222 to generate a noisier sample 224 that becomes an input for the subsequent step. The diffusion process 222 typically applies stochastic noising (i.e., Brownian motion) to the input sample Xₜ. Though shown here as “steps,” the process is typically continuous and defined as a stochastic differential equation. Formally, diffusion models may use Equation 1 to define the differential change in a data point noise level t:

$${dX}_{t} = f ( {X}_{t} , t ) dt + g ( t ) {dW}_{t} , {X}_{0} ∼ p ( \cdot , 0 ) \qquad Equation 1$$

in which:
X₀˜p(·, 0) is a data point sampled from the distribution of training data at t=0;
f(Xₜ, t): [symbol] ^{D}×[0,1]→ [symbol] ^{D} is a hyperparameter;
g:[0,1]→ [symbol] ^{D} is a hyperparameter;
Wₜ is a D-dimensional stochastic noising function (i.e., Brownian motion).
   In typical diffusion models, the function f(Xₜ, t) defining the contribution of Xₜ is a linear function of t:

$$f ( x , t ) = b ( t ) x . \qquad Equation 2$$

for a function b:[0,1]→ [symbol] .

Because the diffusion process adds noise at each step, individual data samples may “diffuse” probabilistically to regions of the output space as the noise level is increased until at the noise level of “1” the complete noise level is applied and the data samples probabilistically diffuse across the output space. Using data samples at different noise levels, parameters of the diffusion model 200 are trained in a denoising model 242 that learns to “denoise” the corresponding noise of noise levels of the forward noising process to denoise from noise level 1 to noise level 0. Particularly, at each “step” of the denoising process a step t+1 input 240 is applied to the denoising model 242 to generate step t output sample 244. The denoising model 242 is applied iteratively to reduce the noise level until a generated data sample 250 at noise level t=0. Like the forward noising process, the backward process (Yₜ:=X₁₋ₜ) of denoising model 242 may be modeled continuously as a stochastic differential equation:

$${dY}_{t} = [ {g}^{2} ( 1 - t ) s ( {Y}_{t} , 1 - t ) - f ( {Y}_{t} , 1 - t ) ] dt + g ( 1 - t ) d {\hat{W}}_{t} , \\ {Y}_{0} ∼ p ( \cdot , 1 ) \qquad Equation 3$$

where s(x, t) is a score function learned by parameters of the denoising model 242 (e.g., a neural network model) and aims to learn s(x, t):=∇logp(x,t) where ∇ is differentiation with respect to the data sample x;
Ŵₜ is another D-dimensional stochastic noising function (i.e., Brownian motion); and
Y₀˜p(·,1) denotes initial denoising samples Y₀ drawn from the “fully noised” distribution p(·, 1).

To generate new data samples with the diffusion model 200, the probability distribution 260 may be modeled as a D-dimensional Gaussian distribution. An initial data sample is drawn from the D-dimensional Gaussian distribution and Equation 3 applied from Y₀ to Y₁ to generate denoised generated data sample 250.

As such, diffusion models may apply noise levels during the “forward” noising process, and the denoising process learns parameters for denoising model 242 for “removing” the corresponding noise added by the diffusion process 222. Because data samples may “diffuse” to regions of the output space during the noising process, and the noise is progressively removed to generate data samples, probability density can be evaluated for a data sample at various noise levels. Formally, denoting a distribution of Y₁₋ₜ as \hat{p}(·,t), then \hat{p}(x, t₀) can be evaluated for any given x ∈ [symbol] ^{D} and t₀ ∈ (0, 1]. First, the diffusion model may be interpreted as a continuous normalizing flow, such that a trajectory tr (xtₜ)_{t∈[t}_{₀}_{,1}] can be solved from t₀ to t₁ according to the ordinary differential equation:

$${dx}_{t} = ( f ( {x}_{t} , t ) - \frac{1}{2} {g}^{2} ( t ) s ( {x}_{t} , t ) ) dt , {x}_{{t}_{0}} = x \qquad Equation 4$$

The trajectory tr can then be evaluated with the change-of-variables formula to determine the log probability of a data sample x at time t₀:

$$log p ( x , {t}_{0} ) = log p ( {x}_{1} , 1 ) + {\int }_{{t}_{0}}^{1} tr ( ∇ v ( {x}_{t} , t ) ) dt \qquad Equation 5$$

where log p(x₁, 1) can be evaluated since it is a Gaussian (at the noise level t=1); and
where p(·, 1) can be evaluated since it is a known Gaussian,
v(xₜ, t) is f(x,t)−g²(t)s(x,t)/2; and
∇v(xₜ, t) is differentiation of v(x, t) with respect to x.

Using the change in evaluated probability as estimated by the model parameters (i.e., that are learned parameters for s(x, t)) relative to the noise level can be used to estimate the local intrinsic dimensionality LID_{θ}(x) of the data sample.

For most diffusion models, including variance-exploding, variance-preserving, and sub-variance-preserving diffusion models, and those which define f(x, t)=b(t)x as indicated above, the associated transition kernel p_{t|0} is Gaussian:

$${p}_{t \vert 0} ( {x}_{t} \vert {x}_{0} ) = N ( {x}_{t} ; ψ ( t ) {x}_{0} , {σ}^{2} ( t ) {I}_{D} ) \qquad Equation 6$$

where ψ, σ:[0, 1]→ [symbol] ;
σ is a log standard deviation as a function of t;
I_{D} is an identity matrix,
b and g are such that ψ and σ are differentiable; and
λ(t):=σ(t)/ψ(t) is injective.
In many cases, such as variance-exploding diffusion models, ψ(t)=1.

FIG. 3 provides an example data flow for estimating the local intrinsic dimensionality of a data sample, according to one embodiment. In particular, this approach may determine the local intrinsic dimensionality of a data sample 300 based on a differential probability relative to modifying noise level. To do so, the data sample 300 being evaluated may be assessed at one or more noise levels to determine probability of the data sample at each noise level. As discussed above, the diffusion process 222 may be evaluated for different noise levels by progressing steps of t in the noising process of the diffusion model. Conceptually, the data sample may be evaluated with different noise distributions representing different noise levels associated with different values of t, to yield combinations of the data sample and noise distributions 310A-C associated with the different values of t. For each of the noise levels, related log probabilities 320A-C may be determined for the samples, such that a differential 330 (i.e., a slope) of the change in log probability relative to change in noise level can be determined. While the noise level may be generated by a static process (i.e., unlearned) of the diffusion process, the log probability 320 is determined based on the trained parameters of the model. The relative change in log probability in relation to noise level thus describes a “complexity” of the relationship between the forward diffusion process and backwards denoising process that describes the local intrinsic dimensionality.

In the example of FIG. 3, the differential log probability 330 may be determined by estimating the log probabilities 320A-C at different noise levels described as log standard deviations δ₁, . . . , δₘ and fitting a slope βₓ as the differential log probability per noise 330, such that the estimated LID in some embodiments may be estimated as the dimensionality D of the data space plus the slope βₓ: LID_{θ}(x)˜D+Bₓ.

Because many diffusion models may natively describe noising with respect to a value of t, rather than the log standard deviation δ, for diffusion models with transition kernels that can be written according to Equation 6, the log noise convolution log [symbol] (x, δ) for determining the log probability 320 of a data sample with a log standard deviation δ can be determined in one embodiment according to:

$$log ϱ ( x , δ ) = D log ψ ( t ( δ ) ) + log p ( ψ ( t ( δ ) ) x , t ( δ ) ) \qquad Equation 7$$

where t(δ):=λ⁻¹(e^{δ}).

For each time t and data point, Equation 7 may be solved to obtain the log probabilities 320 with an ordinary differential equation (ODE) solver from which the differential log probability 330 can be determined to estimate the LID 340 of the data sample.

The approach of the example of Equation 7 may be prohibitively expensive when performing several such calls to an ODE solver. However, applying the Fokker-Planck equation associated with the “forward” noising process of Equation 1 allows embodiments using diffusion models with the transition kernel of Equation 6 to define a log probability as a function of increasing log standard deviation directly as:

$$d log ϱ ( x , δ ) = v ( t ( δ ) ; s , x ) d δ , log ϱ ( x , {δ}_{1} ) = 0 \qquad Equation 8$$

Evaluating Equation 8 with an ODE from δ₁ to δₘ produces the trajectory (log [symbol] (x, δ))_{δ∈[}_{₁}_{, δ}_{ₘ}]. The trajectory of log probabilities and associated noise levels can then be regressed to determine the differential log probability 330 and generate the estimated LID as discussed above.

While the approach shown in FIG. 3 can effectively predict the LID based on the slope (i.e., differential) of the log probability based on measured log probabilities at multiple noise levels, these embodiments may still require the use of a differential equation solver and repeated calls to the underlying trained model, for example by requiring computing the trace of the Jacobian of s multiple times within the solver.

FIG. 4 shows an example for estimating a local intrinsic dimensionality at a noise level, according to one embodiment. In the example of FIG. 4, rather than computing the probabilities at multiple noise levels (e.g., with a trajectory of noise levels as in Eq. 8), the incremental log probability per noise is computed directly at a particular noise level t, shown in FIG. 4 as t₂. For sufficiently small rates of change in the noise level (i.e., log standard deviation δ), the rate of change in log probability relative to change in noise level may be directly used to determine the estimated local intrinsic dimensionality of a data sample 400 relative to the model's parameters. As such, a particular noise level (e.g., a specified value of t) may be determined for which to evaluate the data sample, plus the noise distribution 410 at that noise level, from which the log probability 420 and incremental log probability 430 may be directly determined by differentiating the log probability with respect to incremental noise. This incremental log probability may then estimate the LID 440 for a value of t at t₀ based on the

$${LID}_{θ} ( x ) \approx D + \frac{\partial }{\partial δ} log ϱ ( x , {δ}_{0} ) \approx D + v ( t ( {δ}_{0} ) ; s , x ) \qquad Equation 9$$

in which v(x, t) is f(x, t)−g²(t)s(x,t)/2 as defined above; and
D is the dimensionality of the data sample space.

Since v(t(δ); s, x) depends on δ only through t(δ), the value of t₀ can be set directly as the evaluated the hyperparameter rather than δ₀, which avoids potentially cumbersome computation of t(δ₀)=λ⁻¹(e^{δ}^{₀}); thus, instead of setting a suitable negative δ₀, the value of t₀ is set above (but typically close to zero) (i.e., t₀>0). This process for evaluating the LID based on a differential of the noise level at a selected time value is termed FLIPD(x, t₀). By using a value of t and evaluating the change in log probability based on change in noise level, the LID for the data sample can be efficiently computed since the trace of the Jacobian of s is computed once when computing v(t(δ₀); s, x). In addition, this approach does not require an ODE solver and can be estimated for a datapoint with a single hyperparameter defining the relevant noise level (i.e., given by t).

While the evaluation of LID according to Eq. 9 may be expected to be most accurate with evaluated values of t₀ close to zero, in many cases actual trained models exhibit unusual behavior at values of t close to zero. In some embodiments, the value of the selected noise level may thus be calibrated for a particular set of model parameters when evaluating a particular data set.

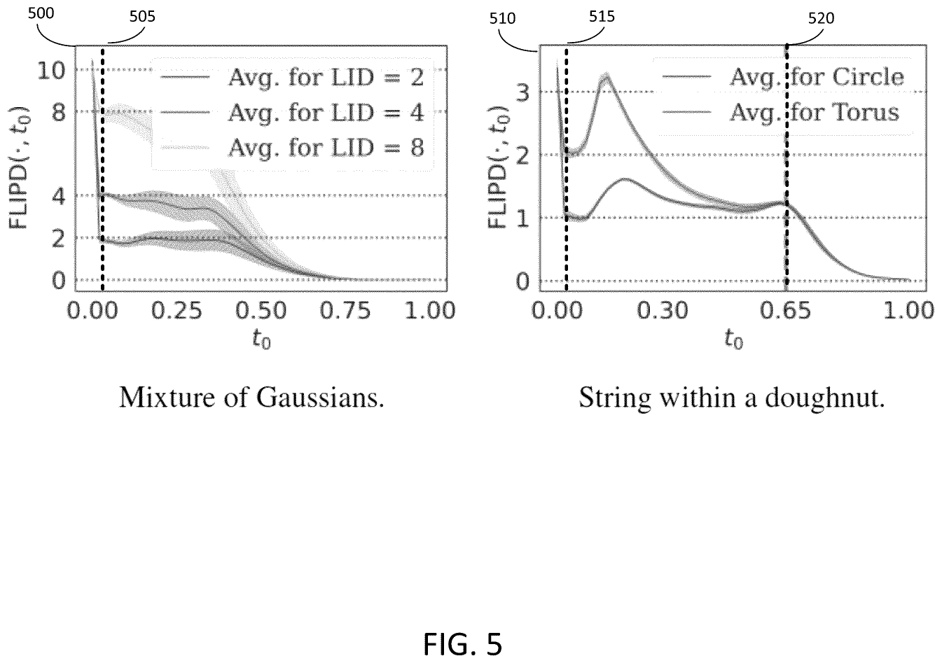

FIG. 5 shows examples of the estimated LID for data samples as the evaluated noise level changes, according to one embodiment. A first graph 500 and second graph 510 shows the value of the evaluated LID according to Equation 9 (FLIPD) as the value of the noise level (characterized by t₀) is changed from zero to one. In the first graph 500, three data sets comprising a mixture of 2, 4, and 8 Gaussians are evaluated. In the second graph 510, a data set includes a “string within a doughnut,” in which a three-dimensional space has a set of data points forming a “donut” of a two-dimensional torus (having a known LID of 2) within which is a “string” as a one-dimensional circle (having a known LID of 1).

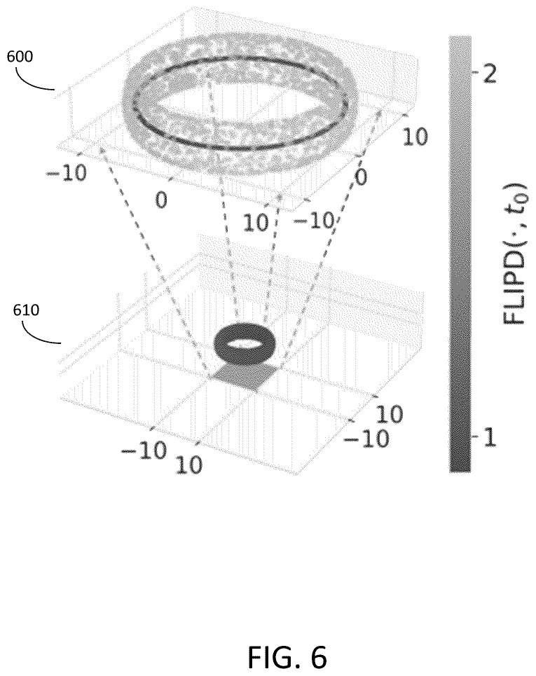

As shown by the first graph 500 and second graph 510, the estimated LID by FLIPD can vary depending on the specified noise level designated by the value of to. In one embodiment, the value of to used to evaluate additional data points may be determined based on a “knee” of the distribution of LID evaluations at the different noise levels. The selected knee is typically selected close to t=0 where the evaluated LID as a function of the noise level changes slope and preferably flattens (the change in evaluated LID relative to change in noise level is substantially close to 0). In the first graph 500, a knee 505 may be identified as the noise level for setting t₀ to evaluate additional data samples. In the second graph 510, a first knee 515 may be identified that differentiates between data from the circle and data from the torus. In this example, a second knee 520 may indicate a noise level at which the circle and the torus appear similarly complex and may be evaluated at the same LID. As further discussed in FIG. 6, different noise levels may represent different “scopes” at which LID may be evaluated.

The value of t₀ may thus be determined by evaluating the LID of one or more data samples at a plurality of noise levels. For example, the plurality of noise levels may include five, ten, fifty, one hundred, or other noising steps (e.g., t=0, 0.1, 0.2, . . . 1.0) for determining the change in estimated LID at different noise levels. The “knee” of the response curve of estimated LID may be determined by various automatic processes for detecting the change in a response slope (e.g., a point of maximum curvature), including the “kneedle” algorithm. By evaluating the estimated LID at various noise levels, a noise level can be selected automatically that most reliably characterizes the data samples in the data set.

Because the denoising model may be unstable at low noise levels, the selection of a noise level at which the values stabilize enables an evaluation according to Equation 9 that avoids the numerical instability and obtains effective values of the LID for the data point according to the trained parameters of the diffusion model.

FIG. 6 shows a further example of how the selection of a noise level can affect LID estimates. FIG. 6 shows an example of selected values of a knee for the “string within a donut” data set, in which some data points are selected from a two-dimensional torus and others from a one-dimensional string within the torus. The varying noise levels may represent different “scales” at which to view the complexity of the data samples, such that “lower” noise levels (t closer to zero) represents more fine-grained analysis of the data samples, while “higher” noise levels (t closer to 1) represents complexity at a less-granular level (because increasingly large details are smoothed/removed by the additional noise). A first graph 600 of data samples at a lower noise level, t₀=0.05, shows that with a smaller noise level, the data points from the torus and from the circle are differently (and correctly) evaluated. The data points from the torus are evaluated as having an LID of 2, while the data points from the circle are evaluated as having an LID of 1. However, when the noise level is increased to t₀=0.65 as shown in the second graph 610, the added noise blends the torus with the circle, such that data samples from both the circle and the torus appear (with this noise level) are evaluated at the same LID of 1. The different evaluated LIDs of data samples at different noise levels may be used to determine additional characteristics of the data set, for example revealing complexities of the data that appear (or disappear) at different scales.

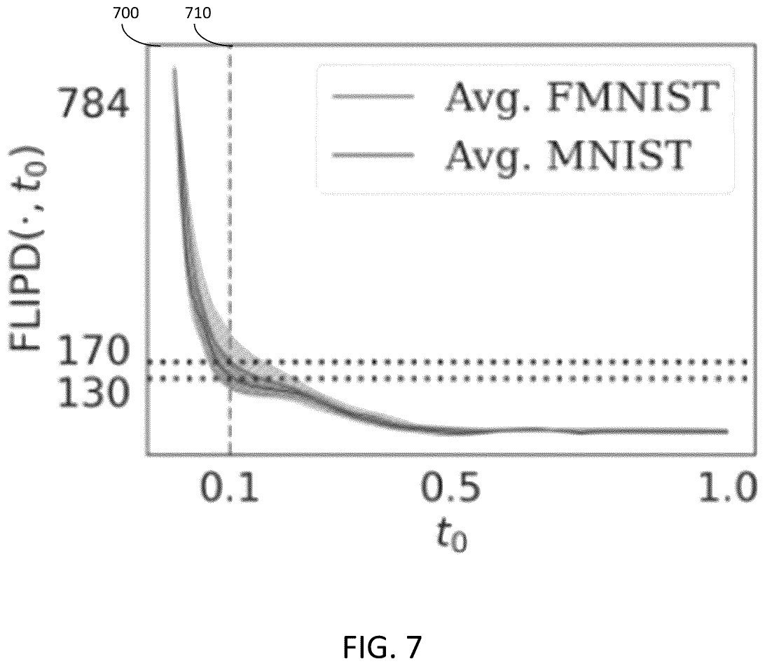

FIG. 7 shows an additional example of determining a noise level for evaluating local intrinsic dimensionality. In this example, FLIPD is applied to diffusion models trained on the MNIST and FMNIST data sets as shown in graph 700. Consistent with examples on other data sets, the data for the MNIST and FMNIST appears unstable with t₀ close to zero. Coincidentally, the “kneedle” algorithm identifies a knee 710 of LID estimates at t₀=0.1 for both data sets. In addition to demonstrating this approach for LID estimation is effective for non-simulated data, the identified LID for data points at the knee yields average LID values of 130 for MNIST and 170 for FMNIST that is consistent with other approximations of the complexity of these data sets.

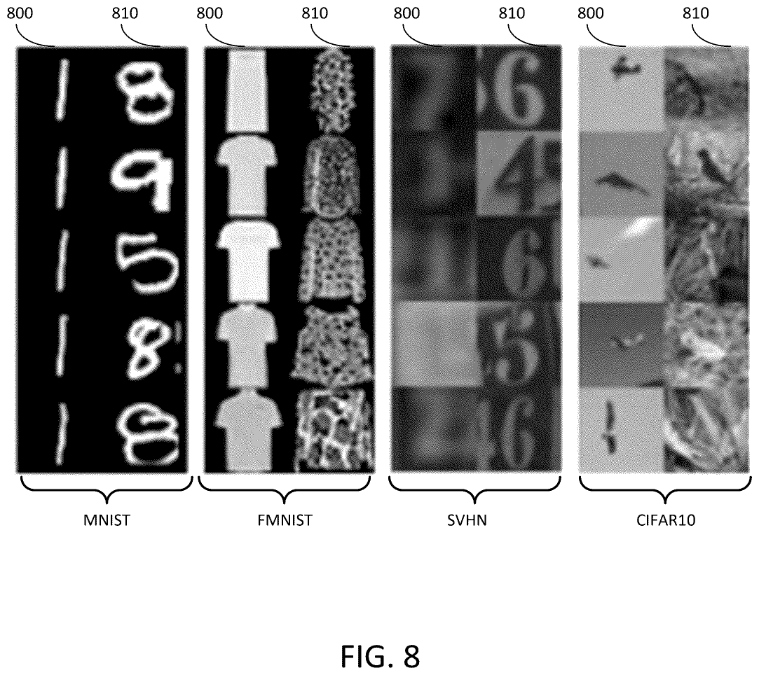

FIG. 8 provides an additional illustration of the estimated local intrinsic dimensionality of data points in a variety of data sets, according to one embodiment. In this example, FLIPD is applied to diffusion models with various data sets MNIST, FMNIST, SVHN, and CIFAR10 with a selected noise level based on a knee of the evaluated LID estimates as discussed above. After selecting the noise level, the LID of the data samples is evaluated at the selected noise level. For each data set, FIG. 8 shows the lowest-LID data samples 800 and the highest-LID data samples 810. Consistent with the understanding of LID as describing complexity, the LID scores generated by FLIPD appropriately captures intuitive complexity for images in these data sets. Particularly, the lowest-LID data samples 800 from each data set appears comparatively simpler and with fewer details than then higher-LID data samples 810.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for determining a local intrinsic dimensionality for a data sample according to a pre-trained diffusion model, comprising:
one or more processors; and
one or more non-transitory computer-readable media having instructions executable by the one or more processors for:
determining a noise level for the data sample based on a forward diffusion process of the pre-trained diffusion model;
determining a log probability of the data sample with the noise level based on a trained denoising model of the pre-trained diffusion model;
determining a differential log probability of the data sample with respect to the noise level based on the log probability of the data sample; and
estimating the local intrinsic dimensionality of the data sample according to the pre-trained diffusion model based on the differential log probability.

2. The system of claim 1, wherein the noise level is determined for a selected step of a continuous noising function.

3. The system of claim 2, wherein the instructions are further executable for determining the selected step based on a knee of a plurality of local intrinsic dimensionalities evaluated at a plurality of noise levels.

4. The system of claim 1, wherein the differential log probability is calculated without a differential equation solver.

5. The system of claim 1, wherein the diffusion model is defined as one or more continuous differential equations.

6. The system of claim 1, wherein determining the differential log probability comprises applying a Fokker-Planck equation to the forward diffusion process.

7. The system of claim 1, wherein the log probability is determined at a plurality of noise levels and the differential log probability is determined as a slope of the log probability with respect to the plurality of noise levels.

8. A method for determining a local intrinsic dimensionality for a data sample according to a pre-trained diffusion model, comprising:
determining a noise level for the data sample based on a forward diffusion process of the pre-trained diffusion model;
determining a log probability of the data sample with the noise level based on a trained denoising model of the pre-trained diffusion model;
determining a differential log probability of the data sample with respect to the noise level based on the log probability of the data sample; and
estimating the local intrinsic dimensionality of the data sample according to the pre-trained diffusion model based on the differential log probability.

9. The method of claim 8, wherein the noise level is determined for a selected step of a continuous noising function.

10. The method of claim 9, wherein the instructions are further executable for determining the selected step based on a knee of a plurality of local intrinsic dimensionalities evaluated at a plurality of noise levels.

11. The method of claim 8, wherein the differential log probability is calculated without a differential equation solver.

12. The method of claim 8, wherein the diffusion model is defined as one or more continuous differential equations.

13. The method of claim 8, wherein determining the differential log probability comprises applying a Fokker-Planck equation to the forward diffusion process.

14. The method of claim 8, wherein the log probability is determined at a plurality of noise levels and the differential log probability is determined as a slope of the log probability with respect to the plurality of noise levels.

15. A non-transitory computer-readable medium for determining a local intrinsic dimensionality for a data sample according to a pre-trained diffusion model, comprising instructions that, when executed by a processor, cause the processor to:
determine a noise level for the data sample based on a forward diffusion process of the pre-trained diffusion model;
determine a log probability of the data sample with the noise level based on a trained denoising model of the pre-trained diffusion model;
determine a differential log probability of the data sample with respect to the noise level based on the log probability of the data sample; and
estimate the local intrinsic dimensionality of the data sample according to the pre-trained diffusion model based on the differential log probability.

16. The non-transitory computer-readable medium of claim 15, wherein the noise level is determined for a selected step of a continuous noising function.

17. The non-transitory computer-readable medium of claim 16, wherein the instructions, when executed by the processor, further cause the processor to determine the selected step based on a knee of a plurality of local intrinsic dimensionalities evaluated at a plurality of noise levels.

18. The non-transitory computer-readable medium of claim 15, wherein the differential log probability is calculated without a differential equation solver.

19. The non-transitory computer-readable medium of claim 15, wherein the diffusion model is defined as one or more continuous differential equations.

20. The non-transitory computer-readable medium of claim 15, wherein determining the differential log probability comprises applying a Fokker-Planck equation to the forward diffusion process.
